(19) United States
(12) Patent Application Publication
(10) Pub. No.: US 2026/0236304 A1
(43) Pub. Date: Aug. 13, 2026

(54) MEMORY RECLAIMING METHOD, DEVICE, STORAGE MEDIUM, AND SYSTEM

(71) Applicant: CLOUD INTELLIGENCE ASSETS HOLDING (SINGAPORE) PRIVATE LIMITED, Singapore (SG)

(72) Inventors: Yunqi HAN, Beijing (CN); Xiangzheng SUN, Beijing (CN); Liang YOU, Beijing (CN)

(21) Appl. No.: 19/160,377

(22) PCT Filed: Apr. 12, 2024
(86) PCT No.: PCT/CN2024/087511

§ 371 Date: Aug. 27, 2025

(30) Foreign Application Priority Data
Apr. 18, 2023 (CN) 202310427928.7

(51) Int. Cl. G06F 9/50

(52) U.S. Cl. CPC G06F 9/5016

(57) ABSTRACT

The present disclosure provides a memory reclaiming method, a device, a storage medium, and a system. The method includes: a reclaiming thread incrementally updating, in response to a reclaiming request triggered for a target memory space, a first version number currently corresponding to the reclaiming thread to obtain a second version number, and determining the second version number as a version number corresponding to the target memory space; sending, in response to a version number obtaining request, a third version number currently corresponding to the reclaiming thread to a target application thread as a version number currently corresponding to the target application thread; and performing reclaiming processing on the target memory space if it is determined, based on a version number respectively corresponding to at least one application thread and the second version number corresponding to the target memory space, that the target memory space satisfies a reclaiming condition.

### CROSS-REFERENCE TO RELATED APPLICATIONS

This application is a national stage of International Application No. PCT/CN 2024/087511, filed on Apr. 12, 2024, which claims priority to Chinese Patent Application No. 202310427928.7, entitled “MEMORY RECLAIMING METHOD, DEVICE, STORAGE MEDIUM, AND SYSTEM” and filed with the China National Intellectual Property Administration on Apr. 18, 2023. Both of the aforementioned applications are incorporated herein by reference in their entireties.

### TECHNICAL FIELD

The present disclosure relates to the field of computer technologies, and in particular, to a memory reclaiming method, a device, a storage medium, and a system.

### BACKGROUND

In an electronic device such as a mobile phone, a notebook computer, or a server, when an application is started, a corresponding process is started, and the process applies for one or more independent memory spaces. In addition, the process may start a plurality of threads (referred to as application threads) to execute tasks that need to be executed in a running process of the application. In a task execution process, the plurality of threads may access a same memory space. When the memory space is no longer accessed, the memory space may be reclaimed, to improve memory utilization.

In the foregoing case in which the plurality of application threads access the same memory space, a smart pointer is usually used to maintain a life cycle of the memory space. During specific implementations, each application thread needs to perform construction and destruction operations on the smart pointer each time it accesses the memory space. For example, when an application thread accesses a memory space, a smart pointer that points to the memory space is first constructed, and a value of an atomic counter in the smart pointer is incremented by one. After the application thread completes accessing the memory space, the smart pointer is destructed, to decrement the value of the atomic counter by one. The plurality of application threads share the atomic counter, and reclaiming processing may be performed on the memory space once the value of the atomic counter reaches zero. However, in this process, an atomic operation is required to ensure atomicity between the plurality of application threads. The atomic operation and the repeated construction and destruction of the smart pointer consume a lot of performance.

### SUMMARY

Embodiments of the present disclosure provide a memory reclaiming method, a device, a storage medium, and a system, to reduce performance overheads during memory reclaiming.

According to a first aspect, an embodiment of the present disclosure provides a memory reclaiming method, applied to a reclaiming thread that reclaims a target memory space jointly accessed by at least one application thread. The method includes: incrementally updating, in response to a reclaiming request triggered for the target memory space at a first moment, a first version number currently corresponding to the reclaiming thread to obtain a second version number; determining the second version number as a version number corresponding to the target memory space; sending, in response to a version number obtaining request that is triggered at a second moment after a target application thread among the at least one application thread completes execution of a task, a third version number currently corresponding to the reclaiming thread to the target application thread as a version number currently corresponding to the target application thread, where the target application thread is any one of the at least one application thread; and performing reclaiming processing on the target memory space if it is determined, based on a version number respectively corresponding to the at least one application thread and the second version number corresponding to the target memory space, that the target memory space satisfies a reclaiming condition.

According to a second aspect, an embodiment of the present disclosure provides a memory reclaiming apparatus, applied to a reclaiming thread that reclaims a target memory space jointly accessed by at least one application thread. The apparatus includes: a determining module, configured to: incrementally update, in response to a reclaiming request triggered for the target memory space at a first moment, a first version number currently corresponding to the reclaiming thread to obtain a second version number; and determine the second version number as a version number corresponding to the target memory space; a sending module, configured to: send, in response to a version number obtaining request that is triggered at a second moment after a target application thread among the at least one application thread completes execution of a task, a third version number currently corresponding to the reclaiming thread to the target application thread as a version number currently corresponding to the target application thread, where the target application thread is any one of the at least one application thread; and a reclaiming module, configured to perform reclaiming processing on the target memory space if it is determined, based on a version number respectively corresponding to the at least one application thread and the second version number corresponding to the target memory space, that the target memory space satisfies a reclaiming condition.

According to a third aspect, an embodiment of the present disclosure provides an electronic device, including: a memory, a processor, and a communication interface, where the memory stores executable code, and when the executable code is executed by the processor, the processor is enabled to perform the memory reclaiming method according to the first aspect.

According to a fourth aspect, an embodiment of the present disclosure provides a non-transitory machine-readable storage medium, where the non-transitory machine-readable storage medium stores executable code, and when the executable code is executed by a processor of an electronic device, the processor is enabled to perform the memory reclaiming method according to the first aspect.

According to a fifth aspect, an embodiment of the present disclosure provides a memory reclaiming method, applied to a target application thread among at least one application thread that jointly accesses a target memory space. The method includes: triggering a reclaiming request for the target memory space to a reclaiming thread at a first moment, to enable the reclaiming thread to incrementally update a first version number currently corresponding to the reclaiming thread to obtain a second version number, and determine the second version number as a version number corresponding to the target memory space, where the reclaiming thread corresponds to the at least one application thread; and sending a version number obtaining request to the reclaiming thread at a second moment after execution of a task is completed, to enable the reclaiming thread to send a third version number currently corresponding to the reclaiming thread to the target application thread as a version number currently corresponding to the target application thread, where the target application thread is any one of the at least one application thread; where a version number respectively corresponding to the at least one application thread and the second version number corresponding to the target memory space are configured for enabling the reclaiming thread to perform reclaiming processing on the target memory space when the reclaiming thread determines that the target memory space satisfies a reclaiming condition.

According to a sixth aspect, an embodiment of the present disclosure provides a memory reclaiming apparatus, applied to a target application thread among at least one application thread that jointly accesses a target memory space. The apparatus includes: a sending module, configured to trigger a reclaiming request for the target memory space to a reclaiming thread at a first moment, to enable the reclaiming thread to incrementally update a first version number currently corresponding to the reclaiming thread to obtain a second version number, and determine the second version number as a version number corresponding to the target memory space, where the reclaiming thread corresponds to the at least one application thread; and the sending module is further configured to send a version number obtaining request to the reclaiming thread at a second moment after execution of a task is completed, to enable the reclaiming thread to send a third version number currently corresponding to the reclaiming thread to the target application thread as a version number currently corresponding to the target application thread, where the target application thread is any one of the at least one application thread; and a determining module, configured to determine the third version number as a version number currently corresponding to the target application thread, where a version number respectively corresponding to the at least one application thread and the second version number corresponding to the target memory space are configured for enabling the reclaiming thread to perform reclaiming processing on the target memory space when the reclaiming thread determines that the target memory space satisfies a reclaiming condition.

According to a seventh aspect, an embodiment of the present disclosure provides an electronic device, including: a memory, a processor, and a communication interface, where the memory stores executable code, and when the executable code is executed by the processor, the processor is enabled to perform the memory reclaiming method according to the fifth aspect.

According to an eighth aspect, an embodiment of the present disclosure provides a non-transitory machine-readable storage medium, where the non-transitory machine-readable storage medium stores executable code, and when the executable code is executed by a processor of an electronic device, the processor is enabled to perform the memory reclaiming method according to the fifth aspect.

According to a ninth aspect, an embodiment of the present disclosure provides a memory reclaiming system. The memory reclaiming system includes: at least one application thread jointly accessing a target memory space and a reclaiming thread corresponding to the at least one application thread, where a first application thread among the at least one application thread is configured to trigger a reclaiming request for the target memory space to the reclaiming thread at a first moment; a second application thread among the at least one application thread is configured to send a version number obtaining request to the reclaiming thread at a second moment after execution of a task is completed, and the second application thread is any one of the at least one application thread; and the reclaiming thread is configured to: incrementally update, in response to the reclaiming request, a first version number currently corresponding to the reclaiming thread to obtain a second version number, and determine the second version number as a version number corresponding to the target memory space; send, in response to the version number obtaining request, a currently corresponding third version number to the second application thread as a version number currently corresponding to the second application thread; and perform reclaiming processing on the target memory space if it is determined, based on a version number respectively corresponding to the at least one application thread and the second version number corresponding to the target memory space, that the target memory space satisfies a reclaiming condition.

### BRIEF DESCRIPTION OF DRAWINGS

To describe the technical solutions in embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a memory reclaiming system according to an embodiment of the present disclosure.

FIG. 2 is a flowchart of a memory reclaiming method according to an embodiment of the present disclosure.

FIG. 3 is a schematic diagram of application of a memory reclaiming method according to an embodiment of the present disclosure.

FIG. 4 is a flowchart of a memory reclaiming method according to an embodiment of the present disclosure.

FIG. 5 is a schematic diagram of application of a memory reclaiming method according to an embodiment of the present disclosure.

FIG. 6 is a flowchart of a memory reclaiming method according to an embodiment of the present disclosure.

FIG. 7 is a flowchart of another memory reclaiming method according to an embodiment of the present disclosure.

FIG. 8 is a schematic diagram of a memory reclaiming apparatus according to an embodiment of the present disclosure.

FIG. 9 is a schematic diagram of another memory reclaiming apparatus according to an embodiment of the present disclosure.

FIG. 10 is a schematic structural diagram of an electronic device according to an embodiment of the present disclosure.

### DETAILED DESCRIPTION

To make the objectives, technical solutions, and advantages of embodiments of the present disclosure clearer, the following clearly and completely describes the technical solutions in the embodiments of the present disclosure with reference to the accompanying drawings in the embodiments of the present disclosure. Apparently, the described embodiments are some rather than all of the embodiments of the present disclosure. Based on the embodiments of the present disclosure, all other embodiments obtained by a person of ordinary skill in the art without paying creative efforts shall fall within the protection scope of the present disclosure. In addition, a time sequence of steps in the following method embodiments is merely an example, and is not strictly limited.

It should be noted that, user information (including, but not limited to, user equipment information, user personal information, and the like) and data (including, but not limited to, data for analysis, stored data, displayed data, and the like) involved in the embodiments of the present disclosure all are information and data authorized by a user or fully authorized by each party. The collection, use, and processing of relevant data need to comply with relevant laws, regulations, and standards of relevant countries and regions, and corresponding operation portals are provided for the user to choose to authorize or refuse.

Terms involved in the embodiments of the present disclosure are described below:
Process: It is a basic unit of allocating and managing resources by a concurrently executed program in an execution process. In brief, a process is an application that is running in a system.
Thread: It is an execution unit in a process, and is included in the process. A plurality of threads may be concurrently started in a process. In the embodiments of the present disclosure, to distinguish between two different threads, the threads are respectively named an application thread and a reclaiming thread. The application thread is a thread that is started by a process and that is configured for executing the foregoing application, and the reclaiming thread is a thread configured for memory reclaiming.
Version number: In the embodiments of the present disclosure, three types of version numbers are involved, namely, a version number corresponding to a reclaiming thread, a version number corresponding to an application thread, and a version number corresponding to a memory space. The reclaiming thread maintains a monotonically increasing version number, and the version numbers corresponding to the application thread and the memory space are derived from a value assigned to the version number of the reclaiming thread. Therefore, the version number maintained by the reclaiming thread is a main version number.

In actual application, application threads in a same process correspond to a same application, and the application threads may be configured for executing different tasks. For example, an application thread creates a communication connection, and another application thread may transmit data by using the communication connection.

When a process corresponding to an application is started, the process applies for one or more independent memory spaces of the process, and application threads in the process access these memory spaces in a task execution process. For any memory space, in the embodiments of the present disclosure, to reduce performance overheads during memory reclaiming, an additional reclaiming thread is introduced to the process to be specially responsible for reclaiming a memory space applied for by the process. This avoids a memory reclaiming processing process being executed in the application thread, thereby reducing a burden of the application thread and improving an application task processing speed of the application thread. In summary, the reclaiming thread is responsible for ensuring that when a memory space starts to be reclaimed, no application thread accesses (that is, reads and writes) the memory space again, to ensure that the memory space can be securely released. If reclaiming processing is performed when an application thread is accessing this memory space, the access fails, and an error may occur.

To reduce performance overheads generated by memory reclaiming, in the embodiments of the present disclosure, the reclaiming thread locally maintains a monotonically increasing main version number, and assigns values to the version number of the application thread and a version number of a to-be-reclaimed target memory space by using the main version number, so as to determine a reclaiming occasion of the target memory space by comparing a magnitude relationship between the version number of the application thread and the version number of the target memory space. Such an operation of assigning and comparing version numbers has low performance overheads. Processes such as assignment and comparison of version numbers are described with reference to the following embodiments.

In the solutions provided in the embodiments of the present disclosure, one reclaiming thread corresponding to at least one application thread jointly accessing the target memory space is set, and when an application thread among the at least one application thread determines, at a first moment, that the target memory space needs to be reclaimed, a reclaiming request for the target memory space is triggered to the reclaiming thread. The reclaiming thread maintains the monotonically increasing main version number. When receiving the reclaiming request, it is assumed that a current main version number is a first version number, the reclaiming thread incrementally updates the first version number to obtain a second version number, and determines the second version number as a version number corresponding to the target memory space. The second version number corresponding to the target memory space may actually be used as a basis for sequencing in a time sequence, and may reflect a moment at which the reclaiming request is triggered for the target memory space.

In addition, any application thread among the at least one application thread sends a version number obtaining request to the reclaiming thread each time after execution of a task is completed, so as to request to obtain a current main version number of the reclaiming thread, and assign a value to a version number of the application thread by using the obtained main version number. For example, at a second moment, a target application thread completes execution of the task to trigger the version number obtaining request to the reclaiming thread. It is assumed that the main version number currently corresponding to the reclaiming thread is a third version number, the third version number is sent to the target application thread as a version number currently corresponding to the target application thread. If determining, at a specific moment based on a version number respectively corresponding to the at least one application thread and the second version number corresponding to the target memory space, that the target memory space satisfies a reclaiming condition, the reclaiming thread starts to perform reclaiming processing on the target memory space. Satisfying the reclaiming condition indicates that application threads do not access the target memory space when reclaiming of the target memory space starts.

It can be learned that, in the foregoing solution, during a period of waiting for reclaiming of the target memory space, normal access by the application thread to the target memory space is not affected. Whether to start the reclaiming of the target memory space simply depends on assignment and comparison of the version numbers respectively corresponding to the application thread and the target memory space. These operations do not require locking and have low performance overheads. In addition, a memory reclaiming processing process is relatively slow. Using an additional reclaiming thread to complete the memory reclaiming processing process avoids executing the memory reclaiming processing process in the application thread, thereby reducing a burden of the application thread and improving an application task processing speed of the application thread.

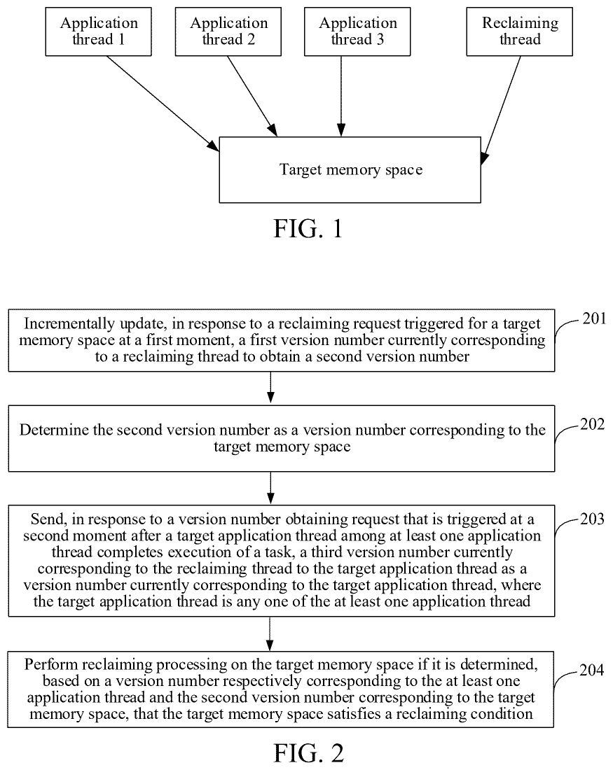

FIG. 1 is a schematic structural diagram of a memory reclaiming system according to an embodiment of the present disclosure. As shown in FIG. 1, the memory reclaiming system includes: at least one application thread jointly accessing a target memory space and a reclaiming thread corresponding to the at least one application thread. For example, FIG. 1 shows a case in which an application thread 1, an application thread 2, and an application thread 3 jointly access the target memory space.

As described above, the at least one application thread and the reclaiming thread may be located in a same process, and the target memory space may be any one of a plurality of memory spaces applied for by the process.

The fact that the plurality of application threads jointly access the target memory space does not mean that the plurality of application threads simultaneously access the target memory space, but there is a possibility that the plurality of application threads access the target memory space in a process of executing their respective tasks.

It may be understood that an access operation performed by the application thread on the target memory space is actually reading or writing data stored in the target memory space.

The reclaiming thread is responsible for performing reclaiming processing on the target memory space. Before reclaiming starts, the application threads can normally access the target memory space. After reclaiming starts, the application threads can no longer access the target memory space.

Based on the foregoing system composition, a process of reclaiming the target memory space is specifically described below.

FIG. 2 is a flowchart of a memory reclaiming method according to an embodiment of the present disclosure. The memory reclaiming method may be executed by the reclaiming thread in FIG. 1. As shown in FIG. 2, the method includes the following steps:
201: Incrementally update, in response to a reclaiming request triggered for a target memory space at a first moment, a first version number currently corresponding to a reclaiming thread to obtain a second version number.
202: Determine the second version number as a version number corresponding to the target memory space.
203: Send, in response to a version number obtaining request that is triggered at a second moment after a target application thread among the at least one application thread completes execution of a task, a third version number currently corresponding to the reclaiming thread to the target application thread as a version number currently corresponding to the target application thread, where the target application thread is any one of the at least one application thread.
204: Perform reclaiming processing on the target memory space if it is determined, based on a version number respectively corresponding to the at least one application thread and the second version number corresponding to the target memory space, that the target memory space satisfies a reclaiming condition.

In actual application, when an application thread among the at least one application thread determines, at the first moment, that the target memory space needs to be reclaimed, a reclaiming request for the target memory space is triggered to the reclaiming thread. The reclaiming request carries a virtual memory address corresponding to the target memory space.

It may be understood that when a process applies for a memory space, a memory address used by the process is usually a virtual memory address rather than a physical memory address. For example, it is assumed that the process applies for two memory spaces, namely, 0-100 and 300-400, when it is determined that a target memory space of 0-100 needs to be reclaimed, the reclaiming request including this virtual memory address is triggered.

In an embodiment, an application thread triggering the reclaiming request may be any one of the at least one application thread. It should be noted that, for the target memory space, regardless of which application thread triggers the reclaiming request, the reclaiming request is triggered only once.

Alternatively, in an embodiment, an application thread triggering the reclaiming request may be an application thread that is among the at least one application thread and that has a permission to trigger the reclaiming request. The application thread having the permission may be determined between application threads in advance by using a negotiation mechanism, or the application thread having the permission may be specified by a process.

For ease of description, regardless of the foregoing situation, it is assumed that a first application thread among the at least one application thread triggers the reclaiming request to the reclaiming thread when determining that the target memory space needs to be reclaimed. It is assumed that a moment at which the reclaiming request is triggered is the first moment.

How the first application thread determines that the target memory space needs to be reclaimed is not specifically limited in the embodiments of the present disclosure. For example, the first application thread determines to reclaim the target memory space after executing a specific task that accesses the target memory space. For example, it is assumed that an application thread 1 creates a communication connection and writes relevant information of the communication connection into the target memory space, an application thread 2 and an application thread 3 may transmit data by using the communication connection. During data transmission, the relevant information of the communication connection is read from the target memory space. For example, if the first application thread is the application thread 1, the application thread 1 may determine, when disconnecting the communication connection, that the target memory space needs to be reclaimed, so as to trigger the reclaiming request to the reclaiming thread at this time (the first moment).

After receiving the reclaiming request, the reclaiming thread determines a main version number (which is assumed to be the first version number) updated at this time, incrementally updates the first version number to obtain the second version number, and uses the second version number as the version number corresponding to the target memory space, that is, sets the version number corresponding to the target memory space to the second version number.

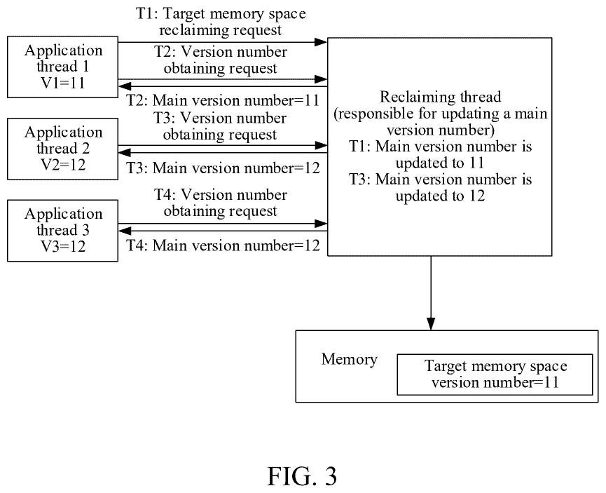

For ease of understanding, an example is used for description with reference to FIG. 3. As described above, the reclaiming thread is responsible for updating the main version number maintained locally, and the main version number is essentially an incremental sequence number, for example, starting from 0 or 1, and incremented by one each time when being updated. For example, it is assumed that at the first moment (T1 shown in FIG. 3), when the reclaiming thread receives the reclaiming request, a current corresponding first version number is 10, the second version number obtained by incrementally updating the first version number is 11 (which is equivalent to performing an operation of adding one on the first version number in this case), and the second version number 11 is used as the version number corresponding to the target memory space, that is, the version number corresponding to the target memory space is set to 11. As shown in FIG. 3, in an embodiment, the reclaiming thread may record a correspondence between the target memory space and the second version number 11 in a set storage space in the memory. Actually, the second version number corresponding to the target memory space is configured for reflecting a moment at which the reclaiming request is triggered for the target memory space.

The at least one application thread can normally access the target memory space provided that reclaiming processing does not start to be performed on the target memory space. In other words, before the first application thread triggers the reclaiming request for the target memory space, the application threads can normally access the target memory space, and after the first application thread triggers the reclaiming request for the target memory space, provided that reclaiming of the target memory space does not start, the application threads can still normally access the target memory space.

Based on this, in the embodiments of the present disclosure, whether before or after the reclaiming request is triggered, any application thread (for ease of description, it is assumed that this application thread is the target application thread) among the at least one application thread may trigger the version number obtaining request to the reclaiming thread each time after execution of the task is completed, so as to request to a current main version number of the reclaiming thread.

With reference to an example in FIG. 3, it is assumed that the target application thread is the application thread 1, completes execution of a task at the second moment (T2 shown in the figure), and sends the version number obtaining request to the reclaiming thread. It is assumed that a current main version number of the reclaiming thread is the third version number, and a value of the third version number is 11 shown in the figure, the third version number 11 is sent to the application thread 1, and the application thread 1 assigns a value to a version number of the application thread 1 by using the third version number 11: V1=11, where VI represents a version number corresponding to the application thread 1.

It should be noted that, FIG. 3 shows a situation in which the second moment T2 is not earlier than the first moment T1, because the reclaiming thread updates the main version number to the second version number 11 at the moment T1, which means that the main version number of the reclaiming thread previously is the first version number 10 that is less than 11. If the moment T2 is earlier than the moment T1, the main version number obtained by the application thread 1 is the first version number 10. In addition, FIG. 3 shows a situation in which the main version number (the third version number) corresponding to the reclaiming thread at the moment T2 is the same as the updated main version number (the second version number) corresponding to the reclaiming thread at the moment T1, that is, before the version number obtaining request triggered by the application thread 1 at the moment T2 is received, the main version number of the reclaiming thread is the second version number and is not updated again.

In addition, with reference to the example in FIG. 3, it may be understood that, it is assumed that at some other moments after the moment T1, each application thread among the at least one application thread receives at least one task that needs to be executed, after completing execution of a task each time, each application thread triggers a version number obtaining request to the reclaiming thread. If the current main version number of the reclaiming thread still remains as the second version number, that is, the third version number corresponding to the reclaiming thread when the version number obtaining request is received is equal to the second version number updated after the reclaiming request is received, a result of assigning a version number to each application thread is 11. However, if it is assumed that before the at least one application thread triggers the version number obtaining request, the main version number of the reclaiming thread has been updated from the second version number to the third version number which is different from the second version number (for example, updated from the second version number 11 to the third version number 12), in this case, each application thread obtains the third version number 12 after sending the version number obtaining request. Based on this, as shown in FIG. 3, it is assumed that the application thread 2 receives the third version number 12 after sending a version number obtaining request at a moment T3, in this case, the version number V2 of the application thread 2 is assigned a value of 12. It is assumed that the application thread 3 receives the third version number 12 after sending a version number obtaining request at a moment T4, in this case, the version number V 3 of the application thread 3 is assigned a value of 12. Both the moment T3 and the moment T4 are not earlier than the moment T2.

In addition, it should be noted that, as described above, the at least one application thread belongs to the same process, and the process applies for a plurality of memory spaces. For example, virtual memory addresses are in two memory spaces, namely, 0-100 and 300-400.It is assumed that the target memory space is the memory space of 0-100, in actual application, when executing the task, the at least one application thread may not access the memory space of 0-100, but may also access the memory space of 300-400. In this embodiment, it is not limited that the at least one application thread sends the version number obtaining request to the reclaiming thread after accessing the memory space of 0-100 to complete execution of the task. Instead, no matter which of the two memory spaces is accessed by an executed task, the at least one application thread sends the version number obtaining request to the reclaiming thread after execution of the task is completed.

From a perspective of any application thread among the at least one application thread, after completing execution of the task each time, any application thread among the at least one application thread does not know whether another task needs to be executed subsequently. Therefore, after completing execution of the task each time, the application thread may consider that the target memory space will no longer be accessed subsequently. In this case, the application thread triggers a version number obtaining request to request that the main version number of the obtained reclaiming thread be assigned to its own version number, so as to indicate when the application thread ends access to the target memory space.

For the target memory space, in an embodiment, after receiving the reclaiming request, the reclaiming thread may periodically determine whether the target memory space should start to be reclaimed. If it is determined at a specific moment that the target memory space can start to be reclaimed, reclaiming processing is started to be performed on the target memory space. Once reclaiming of the target memory space starts, the at least one application thread can no longer access the target memory space.

It is assumed that the reclaiming thread performs a determining process at a moment T5, in this case, the determining process is: determining, based on a version number respectively corresponding to the at least one application thread and the second version number corresponding to the target memory space, whether the target memory space satisfies a reclaiming condition, and performing reclaiming processing on the target memory space if the target memory space satisfies the reclaiming condition. In short, the version number currently corresponding to the target memory space (based on the foregoing descriptions, the version number of the target memory space is the second version number) is compared with the version number currently corresponding to each application thread, to determine whether to start to reclaim the target memory space at the current moment T5. With reference to an example in FIG. 3, the second version number corresponding to the target memory space is 11, the version number corresponding to the application thread 1 is 11, the version numbers corresponding to the application thread 2 and the application thread 3 are 12, and it is determined, based on assignment results of the version numbers, whether to start the reclaiming of the target memory space at the moment T5.

In this embodiment, it is assumed that it is determined that reclaiming processing starts to be performed on the target memory space at the moment T5, a process of performing reclaiming processing on the target memory space may be understood as follows. For the application thread to access the memory space, the application thread uses the virtual memory address, an operating system kernel stores a mapping relationship between the virtual memory address and the physical memory address, and the performing reclaiming processing on the target memory space means: deleting the virtual memory address corresponding to the target memory space and the mapping relationship between the virtual memory address and the corresponding physical memory address, so that the virtual memory address is unavailable to the application threads. Specifically, it is assumed that a process applies for a plurality of memory spaces during startup, and virtual memory addresses corresponding to the plurality of memory spaces are respectively 0-100, 200-300, 500-600, 800-900, and the like. If a memory space corresponding to the virtual memory address in a segment of 0-100 is reclaimed, it means that the application threads in the process can no longer access this segment of memory space subsequently.

Regarding the determination of whether the reclaiming condition is satisfied, in an embodiment, if it is determined that the version number corresponding to each of the at least one application thread is greater than the second version number corresponding to the target memory space, it is determined that reclaiming processing starts to be performed on the target memory space.

In this embodiment, simply, the second version number corresponding to the target memory space and the version number respectively corresponding to the at least one application thread are sorted in an ascending order at a determining moment. If the second version number corresponding to the target memory space is ranked at first, it means that after the reclaiming request is triggered for the target memory space, access of each application thread to the target memory space ends. In other words, before the target memory space is reclaimed, no application thread is accessing the target memory space. In this case, reclaiming of the target memory space can start.

Continuing from the example in FIG. 3, because the second version number of the target memory space is 11, the version number corresponding to the application thread 1 is 11 at the determining moment (the moment T5), and the version numbers corresponding to the application thread 2 and the application thread 3 are 12. Because the version number 11 of the application thread 1 is not greater than the second version number 11 of the target memory space, it is determined that the target memory space cannot start to be reclaimed at the moment T5. Because the target memory space cannot be reclaimed at this time, if receiving a task that needs to access the target memory space, these application threads can still normally access the target memory space to complete task processing. Only after the version numbers corresponding to the application threads are all greater than the second version number corresponding to the target memory space at a specific moment, the target memory space starts to be reclaimed.

For example, at a later moment, the application thread 1 completes execution of a task to trigger the version number obtaining request to the reclaiming thread. In this case, it is assumed that the main version number of the reclaiming thread is updated from the second version number 11 to 13, the version number corresponding to the application thread is assigned to 13. When the determination is performed again (it is assumed to be at a moment T6), because the second version number 11 corresponding to the target memory space is less than all the version numbers corresponding to the application threads (the version number corresponding to the application thread 1 is 13, and the version numbers corresponding to the application thread 2 and the application thread 3 are 12), the reclaiming thread determines to start to reclaim the target memory space at the moment T6.

In actual application, generally, there is still such a case: An application thread among the at least one application thread does not receive a task that needs to be executed within a set duration (such as 5s or 10s), that is, the application thread does not have a task that needs to be executed for a long time, and enters a sleep state. Therefore, a case in which the version number corresponding to the application thread may not be updated for a long time. In this case, it actually means that the application thread no longer accesses the target memory space. Based on this, if an application thread does not receive a task that needs to be processed within the set duration, the application thread may set itself to an inactive state and to sleep. Based on this, in another embodiment, at a determining moment, the reclaiming thread may obtain active state information respectively corresponding to the at least one application thread; and if it is determined, based on the active state information, that an application thread in an inactive state exists among the at least one application thread, the reclaiming thread performs reclaiming processing on the target memory space when determining, based on version number(s) respectively corresponding to application thread(s) other than the application thread in the inactive state and the second version number corresponding to the target memory space, that the target memory space satisfies the reclaiming condition.

During specific implementation, the application threads may record flag information reflecting active states of the application threads into a set storage space in a memory. For example, a flag bit=1 indicates active, and a flag bit=0 indicates inactive. It may be understood that, if after setting a flag bit corresponding to an application thread to 0, the application thread wakes up from the sleep state because it receives a task, the flag bit may be updated to 1.

After the reclaiming thread reads the active states of the application threads from the set storage space in the memory at the determining moment, the reclaiming thread may select application threads in the active states, determine, based on version numbers respectively corresponding to these active application threads and the second version number corresponding to the target memory space, whether the reclaiming condition is satisfied, and perform reclaiming processing on the target memory space if the reclaiming condition is satisfied. In this case, reference may be made to the foregoing embodiments for a method for determining the reclaiming condition, that is, whether the version numbers respectively corresponding to these active application threads are all greater than the second version number corresponding to the target memory space is determined, and if all the version numbers are greater than the second version number corresponding to the target memory space, the reclaiming condition is satisfied; otherwise, the reclaiming condition is not satisfied.

In conclusion, during a period of waiting for reclaiming of the target memory space, normal access by the application thread to the target memory space is not affected. Whether to start the reclaiming of the target memory space simply depends on assignment and comparison of the version numbers respectively corresponding to the application thread and the target memory space. These operations do not require locking and have low performance overheads. In addition, a memory reclaiming processing process is relatively slow. Using an additional reclaiming thread to complete the memory reclaiming processing process avoids executing the memory reclaiming processing process in the application thread, thereby reducing a burden of the application thread and improving an application task processing speed of the application thread.

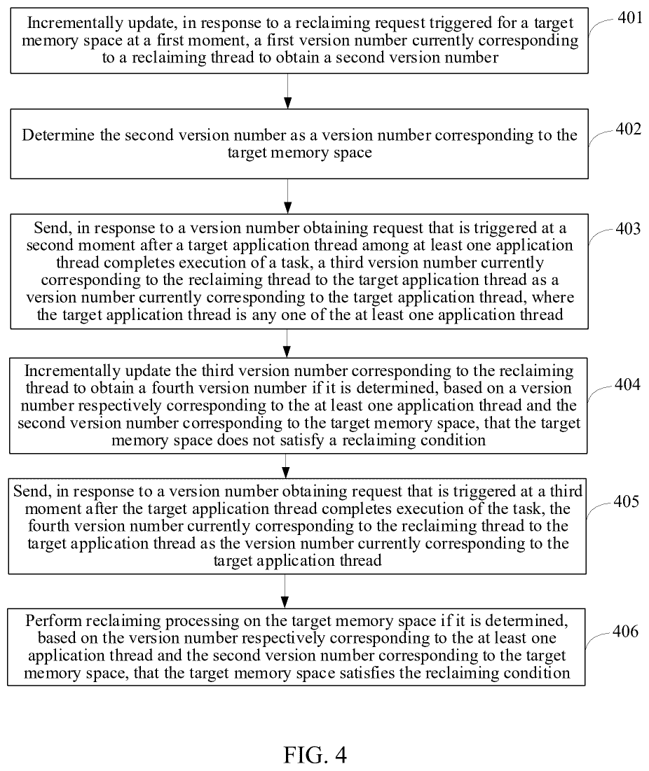

FIG. 4 is a flowchart of a memory reclaiming method according to an embodiment of the present disclosure. As shown in FIG. 4, the method includes:
401: Incrementally update, in response to a reclaiming request triggered for a target memory space at a first moment, a first version number currently corresponding to a reclaiming thread to obtain a second version number.
402: Determine the second version number as a version number corresponding to the target memory space.
403: Send, in response to a version number obtaining request that is triggered at a second moment after a target application thread among at least one application thread completes execution of a task, a third version number currently corresponding to the reclaiming thread to the target application thread as a version number currently corresponding to the target application thread, where the target application thread is any one of the at least one application thread.
404: Incrementally update the third version number corresponding to the reclaiming thread to obtain a fourth version number if it is determined, based on a version number respectively corresponding to the at least one application thread and the second version number corresponding to the target memory space, that the target memory space does not satisfy a reclaiming condition.
405: Send, in response to a version number obtaining request that is triggered at a third moment after the target application thread completes execution of the task, the fourth version number currently corresponding to the reclaiming thread to the target application thread as the version number currently corresponding to the target application thread.
406: Perform reclaiming processing on the target memory space if it is determined, based on the version number respectively corresponding to the at least one application thread and the second version number corresponding to the target memory space, that the target memory space satisfies the reclaiming condition.

This embodiment mainly describes processing logic when the reclaiming thread determines, based on the version number respectively corresponding to the at least one application thread and the second version number corresponding to the target memory space, that the target memory space does not satisfy the reclaiming condition.

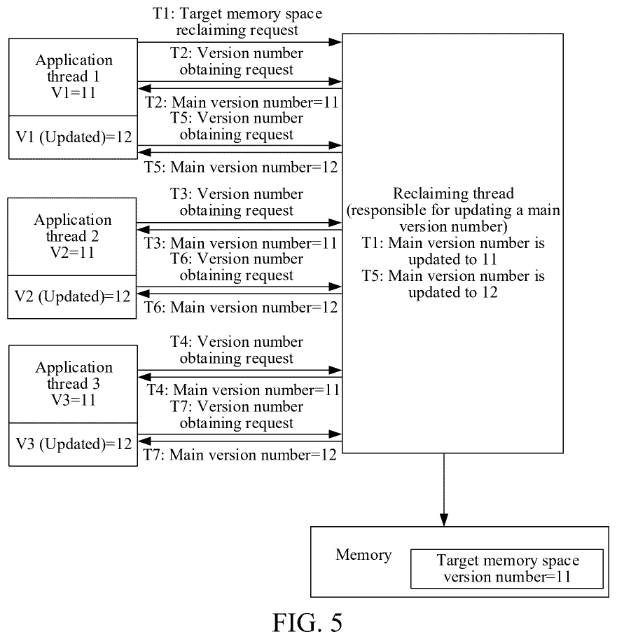

For ease of understanding, an example is used for description with reference to FIG. 5. It is assumed that there are three application threads in total that can access the target memory space, namely, an application thread 1, an application thread 2, and an application thread 3. It is assumed that the application thread 1 triggers the reclaiming request for the target memory space to the reclaiming thread at a moment T1 (a first moment). In this case, it is assumed that a current main version number of the reclaiming thread is a first version number, which is specifically 10. The reclaiming thread adds one to the first version number to obtain a second version number: 11, and records a correspondence between the target memory space and the second version number.

Then, it is assumed that at a moment T2, a moment T3, and a moment T4 (a second moment), the three application threads send version number obtaining requests to the reclaiming thread after completing execution of their respective tasks. Because the current main version number (a third version number, it is assumed that the third version number is the same as the second version number) of the reclaiming thread has been updated to 11, version numbers of the three application threads are all assigned 11.

Then, the reclaiming thread determines, based on the version numbers 11 of the three application threads and the second version number 11 corresponding to the target memory space, that the reclaiming condition is not satisfied, and the reclaiming thread adds one to the third version number to obtain a fourth version number: 12. In other words, the reclaiming thread updates the main version number at this time. It should be noted that the second version number corresponding to the target memory space is not updated.

Updating of the current main version number of the reclaiming thread may affect a version number that is subsequently requested by the application thread. For example, at the third moment after the second moment, for example, the application thread 1 completes execution of a task and requests the version number from the reclaiming thread at a moment T5. In this case, the reclaiming thread feeds back the fourth version number: 12. An assignment result of the version number of the application thread 1 is updated from the previous value of 11 to 12. Similarly, the application thread 2 completes execution of a task and requests the version number from the reclaiming thread at a moment T6. In this case, the reclaiming thread feeds back the fourth version number: 12. The assignment result of the version number of the application thread 2 is updated from the previous value of 11 to 12. The application thread 3 completes execution of a task and requests the version number from the reclaiming thread at a moment T7. In this case, the reclaiming thread feeds back the fourth version number: 12. The assignment result of the version number of the application thread 3 is updated from the previous value of 11 to 12.

Then, when the reclaiming thread determines again, because the version numbers 12 of the three application threads are all greater than the version number 11 corresponding to the target memory space at this time, the reclaiming condition is satisfied, and it is determined that the target memory space can start to be reclaimed at this time.

It can be learned from the foregoing example that, after an application thread triggers the reclaiming request for the target memory space, the reclaiming thread may find, after multiple determinations, that the target memory space can be reclaimed at a future moment.

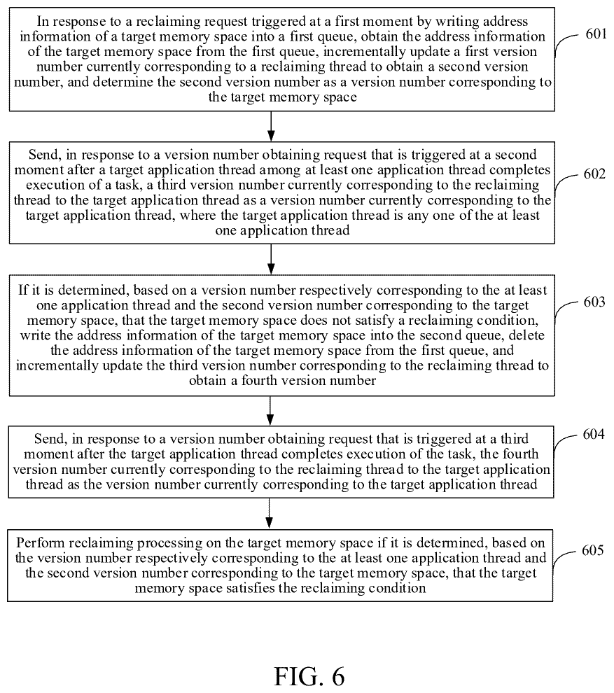

FIG. 6 is a flowchart of a memory reclaiming method according to an embodiment of the present disclosure. The method is executed by a reclaiming thread. As shown in FIG. 6, the method includes:
601: In response to a reclaiming request triggered at a first moment by writing address information of a target memory space into a first queue, obtain the address information of the target memory space from the first queue, incrementally update a first version number currently corresponding to a reclaiming thread to obtain a second version number, and determine the second version number as a version number corresponding to the target memory space.
602: Send, in response to a version number obtaining request that is triggered at a second moment after a target application thread among at least one application thread completes execution of a task, a third version number currently corresponding to the reclaiming thread to the target application thread as a version number currently corresponding to the target application thread, where the target application thread is any one of the at least one application thread.
603: If it is determined, based on a version number respectively corresponding to the at least one application thread and the second version number corresponding to the target memory space, that the target memory space does not satisfy a reclaiming condition, write the address information of the target memory space into the second queue, delete the address information of the target memory space from the first queue, and incrementally update the third version number corresponding to the reclaiming thread to obtain a fourth version number.
604: Send, in response to a version number obtaining request that is triggered at a third moment after the target application thread completes execution of the task, the fourth version number currently corresponding to the reclaiming thread to the target application thread as the version number currently corresponding to the target application thread.

605: Perform reclaiming processing on the target memory space if it is determined, based on the version number respectively corresponding to the at least one application thread and the second version number corresponding to the target memory space, that the target memory space satisfies the reclaiming condition.

In this embodiment, two queues maintained by the reclaiming thread are introduced, namely, the first queue and the second queue, which are configured for marking different states of the target memory space.

Specifically, as described above, it is assumed that a first application thread among the at least one application thread triggers the reclaiming request for the target memory space to the reclaiming thread at the first moment. Specifically, the first application thread may write the address information (that is, a virtual memory address) of the target memory space into the first queue. The first queue triggers a corresponding notification to the reclaiming thread in response to a new write event of address information of the target memory space. In this way, the reclaiming thread determines, based on the notification, from the first queue that the target memory space is written into the first queue, and then performs an update operation of a main version number.

It can be learned that the first application thread triggers the reclaiming request to the reclaiming thread by writing the address information of the target memory space into the first queue.

An example situation in the foregoing embodiment is a case in which when the reclaiming thread receives, at the second moment, a version number obtaining request of any application thread among the at least one application thread, a current main version number is the same as an updated main version number at the first moment, that is, the third version number is the same as the second version number. However, actually, it is assumed that before the reception of the version number obtaining request, the first application thread also initiates the reclaiming request for another memory space, the main version number of the reclaiming thread will be updated from the second version number to the third version number having different values. For example, the at least one application thread is a thread in the same process, the process applies for a plurality of memory spaces, the reclaiming request is triggered for one of the memory spaces at the first moment, and the reclaiming request is triggered for another memory space at a later moment (before the second moment). The reclaiming request at each time causes the main version number of the reclaiming thread to be updated.

After the version number obtaining request sent by a target application thread is received at the second moment, it is assumed that the current main version number of the reclaiming thread is the third version number, the third version number is sent to the target application thread, so as to assign a value to the version number of the target application thread.

In actual application, the reclaiming thread may be configured to perform a process of determining whether the target memory space satisfies the reclaiming condition each time the reclaiming request is received, that is, the reclaiming thread receives the notification that the address information of the target memory space is stored in the first queue, and assigns a value to the version number corresponding to the target memory space.

If a determining result is that the target memory space does not satisfy the reclaiming condition, updating of the main version number of the reclaiming thread is performed once, to obtain the fourth version number, and the target memory space is removed from the first queue and written into the second queue. A memory space stored in the second queue is a memory space waiting to be reclaimed. In other words, after the target memory space is added to the first queue, if the determining process is performed once and it is determined that the target memory space cannot be reclaimed, the target memory space is moved into the second queue to wait to be reclaimed. Specifically, based on a set policy of querying the second queue, after the target memory space stored in the second queue undergoes another one or more subsequent determinations, the target memory space is reclaimed when the reclaiming condition is satisfied, and the target memory space is deleted from the second queue after the reclaiming.

It is assumed that before the next determination, all or some of the at least one application thread send version number obtaining request(s) to the reclaiming thread at the third moment, in this case, the reclaiming thread sends the fourth version number to a corresponding application thread for reassigning a value to the version number.

When the next determination is performed, it is assumed that the reclaiming thread determines that the target memory space satisfies the reclaiming condition, the reclaiming thread determines to start to reclaim the target memory space, and may delete the target memory space from the second queue after the reclaiming is completed.

As described above, each time the reclaiming thread receives the reclaiming request, the reclaiming thread may determine whether the memory space that has been written into the first queue and the second queue satisfies the reclaiming condition. In addition, the reclaiming thread may further determine, for address information of any memory space included in the second queue and based on the version number currently corresponding to each corresponding application thread and a version number corresponding to the any memory space, whether the any memory space satisfies the reclaiming condition when it is determined that the second queue is not empty and the reclaiming request is not received within a set duration.

It should be understood that, after the virtual memory address of the target memory space is stored in the first queue, the version number corresponding to the target memory space is updated, and whether the reclaiming condition is satisfied is determined once. If the determining result is that the reclaiming condition is not satisfied, the virtual memory address of the target memory space is stored in the second queue for subsequent reclaiming. Then, when a next reclaiming request is received, or it is determined that the second queue is not empty and the reclaiming request is not received within the set duration, it means that the reclaiming thread is waken up. The reclaiming thread determines whether the reclaiming condition is satisfied again. If the determining result is still that the reclaiming condition is not satisfied, the target memory space remains in the second queue, awaiting for a next reclaiming. If the reclaiming condition is satisfied, reclaiming processing is directly performed on the target memory space. This is repeated until the second queue is empty, and when the second queue is empty, the reclaiming thread blocks waiting for the application thread to push a new memory space that needs to be reclaimed.

In conclusion, in the embodiments of the present disclosure, during a period of waiting for reclaiming of the target memory space, normal access by the application thread to the target memory space is not affected. Whether to start the reclaiming of the target memory space simply depends on assignment and comparison of the version numbers respectively corresponding to the application thread and the target memory space. These operations do not require locking and have low performance overheads. In addition, a memory reclaiming processing process is relatively slow. Using an additional reclaiming thread to complete the memory reclaiming processing process avoids executing the memory reclaiming processing process in the application thread, thereby reducing a burden of the application thread and improving an application task processing speed of the application thread.

FIG. 7 is a flowchart of another memory reclaiming method according to an embodiment of the present disclosure. The method is applied to at least one application thread jointly accessing a target memory space. As shown in FIG. 7, the method includes the following steps:
701: Trigger a reclaiming request for a target memory space to a reclaiming thread at a first moment, to enable the reclaiming thread to incrementally update a first version number currently corresponding to the reclaiming thread to obtain a second version number, and determine the second version number as a version number corresponding to the target memory space, where the reclaiming thread corresponds to the at least one application thread.
702: Send a version number obtaining request to the reclaiming thread at a second moment after execution of a task is completed, to enable the reclaiming thread to send a third version number currently corresponding to the reclaiming thread to the target application thread as a version number currently corresponding to the target application thread, where the target application thread is any one of the at least one application thread, a version number respectively corresponding to the at least one application thread and the second version number corresponding to the target memory space are configured for enabling the reclaiming thread to perform reclaiming processing on the target memory space when the reclaiming thread determines that the target memory space satisfies a reclaiming condition.

As described above, the application thread triggering the reclaiming request may be a specific application thread among the at least one application thread, or may be any one of the at least one application thread.

As described above, the method further includes: if the target application thread does not receive a task that needs to be executed within a set duration, setting itself to be in an inactive state and then to sleep. The inactive state enables the reclaiming thread to determine, based on version number(s) respectively corresponding to application thread(s) other than the application thread in the inactive state and the second version number corresponding to the target memory space, whether the target memory space satisfies the reclaiming condition.

An execution process of the application thread in this embodiment is not described again, and reference may be made to the descriptions in the foregoing other embodiments.

A memory reclaiming apparatus for one or more embodiments of the present disclosure is described in detail below. A person skilled in the art may understand that these apparatuses may be constructed by using commercial hardware components and configured through steps taught in this solution.

FIG. 8 is a schematic diagram of a memory reclaiming apparatus according to an embodiment of the present disclosure. The apparatus is applied to a reclaiming thread that reclaims a target memory space jointly accessed by at least one application thread. As shown in FIG. 8, the apparatus includes: a determining module 81, a sending module 82, and a reclaiming module 83.

The determining module 81 is configured to: incrementally update, in response to a reclaiming request triggered for the target memory space at a first moment, a first version number currently corresponding to the reclaiming thread to obtain a second version number; and determine the second version number as a version number corresponding to the target memory space.

The sending module 82 is configured to: send, in response to a version number obtaining request that is triggered at a second moment after a target application thread among the at least one application thread completes execution of a task, a third version number currently corresponding to the reclaiming thread to the target application thread as a version number currently corresponding to the target application thread, where the target application thread is any one of the at least one application thread.

The reclaiming module 83 is configured to perform reclaiming processing on the target memory space if it is determined, based on a version number respectively corresponding to the at least one application thread and the second version number corresponding to the target memory space, that the target memory space satisfies a reclaiming condition.

In an embodiment, the reclaiming module 83 is specifically configured to: perform reclaiming processing on the target memory space if it is determined that a version number corresponding to each of the at least one application thread is greater than the second version number corresponding to the target memory space.

In an embodiment, the reclaiming module 83 is specifically configured to: obtain active state information respectively corresponding to the at least one application thread; and if it is determined, based on the active state information, that an application thread in an inactive state exists among the at least one application thread, perform reclaiming processing on the target memory space when determining, based on version number(s) respectively corresponding to application thread(s) other than the application thread in the inactive state and the second version number corresponding to the target memory space, that the target memory space satisfies the reclaiming condition.

In an embodiment, the apparatus further includes: an updating module, configured to incrementally update the third version number corresponding to the reclaiming thread to obtain a fourth version number if it is determined, based on the version number respectively corresponding to the at least one application thread and the second version number corresponding to the target memory space, that the target memory space does not satisfy the reclaiming condition.

In an embodiment, the sending module 82 is further configured to: send, in response to a version number obtaining request that is triggered at a third moment after the target application thread completes execution of a task, the fourth version number currently corresponding to the reclaiming thread to the target application thread as the version number currently corresponding to the target application thread.

In an embodiment, the determining module 81 is specifically configured to: in response to a reclaiming request triggered at the first moment by writing address information of the target memory space into a first queue, obtain the address information of the target memory space from the first queue, incrementally update the first version number currently corresponding to the reclaiming thread to obtain the second version number, write the address information of the target memory space into a second queue configured for storing a memory space waiting to be reclaimed, and delete the address information of the target memory space from the first queue.

In an embodiment, the reclaiming module 83 is specifically configured to: when the reclaiming request is received or it is determined that the second queue is not empty and the reclaiming request is not received within a set duration, for address information of any memory space included in the second queue, determine whether the memory space satisfies the reclaiming condition based on a version number currently corresponding to each corresponding application thread and a version number corresponding to the memory space.

The apparatus shown in FIG. 8 may execute steps executed by the reclaiming thread in the foregoing embodiments. For a detailed execution process and technical effects, refer to descriptions in the foregoing embodiments, and details are not described herein again.

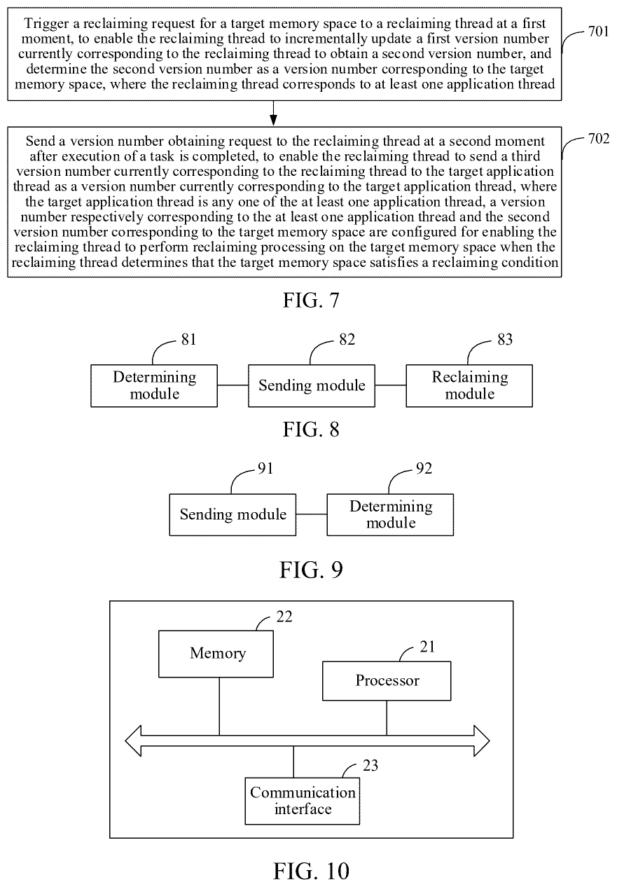

FIG. 9 is a schematic diagram of another memory reclaiming apparatus according to an embodiment of the present disclosure. The apparatus is applied to a target application thread among at least one application thread that jointly accesses a target memory space. As shown in FIG. 9, the apparatus includes: a sending module 91 and a determining module 92.

The sending module 91 is configured to: trigger a reclaiming request for the target memory space to a reclaiming thread at a first moment, to enable the reclaiming thread to incrementally update a first version number currently corresponding to the reclaiming thread to obtain a second version number, and determine the second version number as a version number corresponding to the target memory space, where the reclaiming thread corresponds to the at least one application thread.

The sending module 91 is further configured to send a version number obtaining request to the reclaiming thread at a second moment after execution of a task is completed, to enable the reclaiming thread to send a third version number currently corresponding to the reclaiming thread to the target application thread as a version number currently corresponding to the target application thread, where the target application thread is any one of the at least one application thread.

The determining module 92 is configured to determine the third version number as a version number currently corresponding to the target application thread, where a version number respectively corresponding to the at least one application thread and the second version number corresponding to the target memory space are configured for enabling the reclaiming thread to perform reclaiming processing on the target memory space when the reclaiming thread determines that the target memory space satisfies a reclaiming condition.

In an embodiment, the apparatus further includes: a setting module, configured to set the setting module to be in an inactive state and then to sleep, if a task that needs to be executed is not received within a set duration, where the inactive state enables the reclaiming thread to determine, based on version number(s) respectively corresponding to application thread(s) other than the application thread in the inactive state and the second version number corresponding to the target memory space, whether the target memory space satisfies the reclaiming condition.

The apparatus shown in FIG. 9 may execute steps executed by the application thread in the foregoing embodiments. For a detailed execution process and technical effects, refer to descriptions in the foregoing embodiments, and details are not described herein again.

FIG. 10 is a schematic structural diagram of an electronic device according to an embodiment of the present disclosure. As shown in FIG. 10, the electronic device may include: a processor 21, a memory 22, and a communication interface 23. The memory 22 stores executable code. When the executable code is executed by the processor 21, the processor 21 is enabled to perform the memory reclaiming method in the foregoing embodiments.

In addition, an embodiment of the present disclosure provides a non-transitory machine-readable storage medium. The non-transitory machine-readable storage medium stores executable code, and when the executable code is executed by a processor of an electronic device, the processor is enabled to perform the memory reclaiming method in the foregoing embodiments.

The described apparatus embodiments are merely an example. The units described as separate parts may or may not be physically separate. Some or all of the modules may be selected based on actual requirements to implement the objectives of the solutions of the embodiments. A person of ordinary skill in the art may understand and implement the embodiments of the present disclosure without paying creative efforts.

Based on the descriptions of the foregoing implementations, a person of ordinary skill in the art may clearly understand that the implementations may be implemented by adding a necessary universal hardware platform, and certainly, may alternatively be implemented by a combination of hardware and software. Based on such an understanding, the foregoing technical solutions essentially or a part contributing to the related art may be implemented in a form of a computer product. The present disclosure may use a form of a computer program product that is implemented on one or more computer-usable storage media (including, but not limited to, a magnetic disk memory, a CD-ROM (Compact Disc Read-Only Memory), an optical memory, and the like) that include computer-usable program code.

Finally, it should be noted that: the foregoing embodiments are merely used for describing the technical solutions of the present disclosure, but are not intended to limit the present disclosure. Although the present disclosure is described in detail with reference to the foregoing embodiments, it should be understood by a person skilled in the art that: modifications may still be made to the technical solutions described in the foregoing embodiments, or equivalent replacements may be made to the part of the technical features; and these modifications or replacements do not cause the essence of corresponding technical solutions to depart from the scope of the technical solutions in the embodiments of the present disclosure.

1. A memory reclaiming method, applied to a reclaiming thread that reclaims a target memory space jointly accessed by at least one application thread, wherein the method comprises:
incrementally updating, in response to a reclaiming request triggered for the target memory space at a first moment, a first version number currently corresponding to the reclaiming thread to obtain a second version number;
determining the second version number as a version number corresponding to the target memory space;
sending, in response to a version number obtaining request that is triggered at a second moment after a target application thread among the at least one application thread completes execution of a task, a third version number currently corresponding to the reclaiming thread to the target application thread as a version number currently corresponding to the target application thread, wherein the target application thread is any one of the at least one application thread; and
performing reclaiming processing on the target memory space if it is determined, based on a version number respectively corresponding to the at least one application thread and the second version number corresponding to the target memory space, that the target memory space satisfies a reclaiming condition.

2. The method according to claim 1, wherein the performing reclaiming processing on the target memory space if it is determined, based on a version number respectively corresponding to the at least one application thread and the second version number corresponding to the target memory space, that the target memory space satisfies a reclaiming condition comprises:
performing reclaiming processing on the target memory space if it is determined that a version number corresponding to each of the at least one application thread is greater than the second version number corresponding to the target memory space.

3. The method according to claim 1, wherein the performing reclaiming processing on the target memory space if it is determined, based on a version number respectively corresponding to the at least one application thread and the second version number corresponding to the target memory space, that the target memory space satisfies a reclaiming condition comprises:
obtaining active state information respectively corresponding to the at least one application thread; and
if it is determined based on the active state information that an application thread in an inactive state exists among the at least one application thread, performing reclaiming processing on the target memory space when determining, based on version number(s) respectively corresponding to application thread(s) other than the application thread in the inactive state and the second version number corresponding to the target memory space, that the target memory space satisfies the reclaiming condition.

4. The method according to claim 1, wherein the method further comprises:
incrementally updating the third version number corresponding to the reclaiming thread to obtain a fourth version number if it is determined, based on the version number respectively corresponding to the at least one application thread and the second version number corresponding to the target memory space, that the target memory space does not satisfy the reclaiming condition.

5. The method according to claim 4, wherein the method further comprises:
sending, in response to a version number obtaining request that is triggered at a third moment after the target application thread completes execution of a task, the fourth version number currently corresponding to the reclaiming thread to the target application thread as the version number currently corresponding to the target application thread.

6. The method according to claim 4, wherein the incrementally updating, in response to a reclaiming request triggered for the target memory space at a first moment, a first version number currently corresponding to the reclaiming thread to obtain a second version number comprises:
in response to a reclaiming request triggered at the first moment by writing address information of the target memory space into a first queue, obtaining the address information of the target memory space from the first queue, and incrementally updating the first version number currently corresponding to the reclaiming thread to obtain the second version number; and
if it is determined, based on the version number respectively corresponding to the at least one application thread and the second version number corresponding to the target memory space, that the target memory space does not satisfy the reclaiming condition, the method further comprises:
writing the address information of the target memory space into a second queue configured for storing a memory space waiting to be reclaimed, and deleting the address information of the target memory space from the first queue.

7. The method according to claim 6, wherein the method further comprises:
when the reclaiming request is received or it is determined that the second queue is not empty and the reclaiming request is not received within a set duration, for address information of any memory space comprised in the second queue, determining whether the memory space satisfies the reclaiming condition based on a version number currently corresponding to each corresponding application thread and a version number corresponding to the memory space.

8. A memory reclaiming method, applied to a target application thread among at least one application thread that jointly accesses a target memory space, wherein the method comprises:
triggering a reclaiming request for the target memory space to a reclaiming thread at a first moment, to enable the reclaiming thread to incrementally update a first version number currently corresponding to the reclaiming thread to obtain a second version number, and determine the second version number as a version number corresponding to the target memory space, wherein the reclaiming thread corresponds to the at least one application thread; and
sending a version number obtaining request to the reclaiming thread at a second moment after execution of a task is completed, to enable the reclaiming thread to send a third version number currently corresponding to the reclaiming thread to the target application thread as a version number currently corresponding to the target application thread, wherein the target application thread is any one of the at least one application thread;
wherein a version number respectively corresponding to the at least one application thread and the second version number corresponding to the target memory space are configured for enabling the reclaiming thread to perform reclaiming processing on the target memory space when the reclaiming thread determines that the target memory space satisfies a reclaiming condition.

9. The method according to claim 8, wherein the method further comprises:
setting the reclaiming thread to be in an inactive state and then to sleep, if a task that needs to be executed is not received within a set duration;
wherein the inactive state enables the reclaiming thread to determine, based on version number(s) respectively corresponding to application thread(s) other than the application thread in the inactive state and the second version number corresponding to the target memory space, whether the target memory space satisfies the reclaiming condition.

10. An electronic device, comprising: a memory, a processor, and a communication interface, wherein the memory stores executable code, and when the executable code is executed by the processor, the processor is enabled to:
incrementally update, in response to a reclaiming request triggered for the target memory space at a first moment, a first version number currently corresponding to the reclaiming thread to obtain a second version number;
determine the second version number as a version number corresponding to the target memory space;
send, in response to a version number obtaining request that is triggered at a second moment after a target application thread among the at least one application thread completes execution of a task, a third version number currently corresponding to the reclaiming thread to the target application thread as a version number currently corresponding to the target application thread, wherein the target application thread is any one of the at least one application thread; and
perform reclaiming processing on the target memory space if it is determined, based on a version number respectively corresponding to the at least one application thread and the second version number corresponding to the target memory space, that the target memory space satisfies a reclaiming condition.

11. A non-transitory machine-readable storage medium, wherein the non-transitory machine-readable storage medium stores executable code, and when the executable code is executed by a processor of an electronic device, the processor is enabled to perform the memory reclaiming method according to claim 1.

12. A memory reclaiming system, comprising:
at least one application thread jointly accessing a target memory space and a reclaiming thread corresponding to the at least one application thread, wherein
a first application thread among the at least one application thread is configured to trigger a reclaiming request for the target memory space to the reclaiming thread at a first moment;
a second application thread among the at least one application thread is configured to send a version number obtaining request to the reclaiming thread at a second moment after execution of a task is completed, and the second application thread is any one of the at least one application thread; and
the reclaiming thread is configured to perform the memory reclaiming method according to claim 1.

13. The system according to claim 12, wherein the first application thread is an application thread that is among the at least one application thread and that has a permission to trigger the reclaiming request.

14. The electronic device according to claim 10, wherein the processor is specifically configured to:
perform reclaiming processing on the target memory space if it is determined that a version number corresponding to each of the at least one application thread is greater than the second version number corresponding to the target memory space.

15. The electronic device according to claim 10, wherein the processor is specifically configured to:
obtain active state information respectively corresponding to the at least one application thread; and
if it is determined based on the active state information that an application thread in an inactive state exists among the at least one application thread, perform reclaiming processing on the target memory space when determining, based on version number(s) respectively corresponding to application thread(s) other than the application thread in the inactive state and the second version number corresponding to the target memory space, that the target memory space satisfies the reclaiming condition.

16. The electronic device according to claim 10, wherein the processor is further configured to:
incrementally update the third version number corresponding to the reclaiming thread to obtain a fourth version number if it is determined, based on the version number respectively corresponding to the at least one application thread and the second version number corresponding to the target memory space, that the target memory space does not satisfy the reclaiming condition.

17. The electronic device according to claim 16, wherein the processor is further configured to:
send, in response to a version number obtaining request that is triggered at a third moment after the target application thread completes execution of a task, the fourth version number currently corresponding to the reclaiming thread to the target application thread as the version number currently corresponding to the target application thread.

18. The electronic device according to claim 16, wherein the processor is specifically configured to:
in response to a reclaiming request triggered at the first moment by writing address information of the target memory space into a first queue, obtain the address information of the target memory space from the first queue, and incrementally update the first version number currently corresponding to the reclaiming thread to obtain the second version number; and
write the address information of the target memory space into a second queue configured for storing a memory space waiting to be reclaimed, and delete the address information of the target memory space from the first queue.

19. An electronic device, comprising: a memory, a processor, and a communication interface, wherein the memory stores executable code, and when the executable code is executed by the processor, the processor is enabled to perform the memory reclaiming method according to claim 8.

20. A non-transitory machine-readable storage medium, wherein the non-transitory machine-readable storage medium stores executable code, and when the executable code is executed by a processor of an electronic device, the processor is enabled to perform the memory reclaiming method according to claim 8.
